(19) United States
(12) Patent Application Publication
(10) Pub. No.: US 2021/0174216 A1
(43) Pub. Date: Jun. 10, 2021

(54) SIGNALING CONCEPT DRIFT DURING KNOWLEDGE BASE POPULATION

(71) Applicant: International Business Machines Corporation, Armonk, NY (US)

(72) Inventors: Robert G. Farrell, Cornwall, NY (US); Nicolas Rodolfo Fauceglia, New York, NY (US); Alfio Massimiliano Gliozzo, Brooklyn, NY (US)

(21) Appl. No.: 16/702,787

(22) Filed: Dec. 4, 2019

(51) Int. Cl. G06N 5/02

(52) U.S. Cl. CPC G06N 5/02

(57) ABSTRACT

An approach is provided for signaling concept drift during knowledge base population. A knowledge graph and a collection of text is received, and a vector space is built. A sequence of data items associated with a type of entity or a relation is received. Entities or relations from the knowledge graph are embedded into the vector space to generate entity or relation vectors. Data items associated with the type of entity or the relation are embedded into the vector space to generate data item vectors. An emerging entity or relation concept vector is computed by determining a centroid of the data item vectors. An entity or relation concept vector is computed by determining a centroid of the entity or relation vectors. A signal is generated when a distance between the emerging entity or relation concept vector and the entity or relation concept vector is greater than a threshold.

### TECHNICAL FIELD

The present invention relates to systems and methods for populating a knowledge base. More specifically, the invention relates to systems and methods for signaling concept drift during knowledge base population.

### BACKGROUND

Concept drift refers to the phenomenon that concepts change their meaning over time. When populating a knowledge base or knowledge graph, concept drift can result in a divergence between the intentional meaning of the types of entities and their relationships in the graph and the extensional meaning of the examples of entities and their relationships in documents being used to populate the graph. The clusters of entities and relationships can become less cohesive, thus changing the meaning of the types of entities and their relationships in the graph. This may disadvantageously result in the knowledge graph being less accurate over time. Known knowledge base population techniques provide no way of determining when concept drift occurs over time, and further provide no way of signaling to a user when concept drift occurs.

### SUMMARY

An embodiment of the present invention relates to a method, and associated computer system and computer program product for signaling concept drift during knowledge base population. One or more processors of a computer system receive a knowledge graph and a collection of text. The one or more processors of the computer system build a vector space of the collection of text. The one or more processors of the computer system further receive a sequence of data items associated with: A) a type of entity; or B) a relation, in the knowledge graph. The one or more processors of the computer system embed entities or relations from the knowledge graph into the vector space to generate entity or relation vectors. The one or more processors of the computer system further embed data items associated with: A) the type of entity; or B) the relation into the vector space to generate data item vectors. The one or more processors of the computer system compute an emerging entity or relation concept vector by determining a centroid of the data item vectors and further compute an entity or relation concept vector by determining a centroid of the entity or relation vectors. The one or more processors of the computer system further generate a signal when a distance between the emerging entity or relation concept vector and the entity or relation concept vector is greater than a concept drift threshold.

The aforementioned embodiment advantageously signals when new entities and new relationships between entities begin to diverge from the types of entities and relations already in the knowledge graph. The present invention, for the first time, provides a user with an indication when an emerging concept is diverging significantly from a concept embodied by a knowledge graph. This improvement to the art of knowledge graphs utilizes vector space models to compute emerging concepts for new data items being added to a knowledge graph and to compute concepts for the existing entities and relations in the knowledge graph to provide insight to users related to concept drift.

In one optional aspect of the aforementioned embodiment, the building the vector space of the received sequence of data items uses embeddings and autoencoders. In another optional aspect of the aforementioned embodiment, the generating the signal includes highlighting data items according to a degree of difference with the centroid of the data item vectors. In another optional aspect of the aforementioned embodiment, the generating the signal includes presenting a data item outlier. In another optional aspect of the aforementioned embodiment, the distance is computed as a cosine distance or dot product distance. In another optional aspect of the aforementioned embodiment, the building the vector space of the received sequence of data items further includes building a graph of data item tuples where the magnitude of the vector is computed using a graph metric. In another optional aspect of the aforementioned embodiment, the sequence of data items corresponds to at least one of a recent time window or a data entry, and is generated by a program.

### BRIEF DESCRIPTION OF THE DRAWINGS

FIG. 1 depicts a block diagram of a system for signaling concept drift during knowledge base population, in accordance with embodiments of the present invention.

FIG. 2 depicts a knowledge graph created by the system for signaling concept drift during knowledge base population of FIG. 1, in accordance with embodiments of the present invention.

FIG. 3 depicts a process flow performed by the system for signaling concept drift during knowledge base population of FIG. 1, in accordance with embodiments of the present invention.

FIG. 4 depicts a method for signaling concept drift during knowledge base population, in accordance with embodiments of the present invention.

FIG. 5 depicts another method for signaling concept drift during knowledge base population, in accordance with embodiments of the present invention.

FIG. 6 depicts a block diagram of an exemplary computer system that may be included in the system for signaling concept drift during knowledge base population of FIG. 1, capable of implementing process flows and methods for signaling concept drift during knowledge base population of FIGS. 3-5, and creating the knowledge graph vector space of FIG. 2, in accordance with embodiments of the present invention.

FIG. 7 depicts a cloud computing environment, in accordance with embodiments of the present invention.

FIG. 8 depicts abstraction model layers, in accordance with embodiments of the present invention.

### DETAILED DESCRIPTION

Embodiments of the present invention are configured to warn a user when concept drift occurs in a knowledge graph or during knowledge base population. When populating a knowledge graph, concept drift can result in divergence from the intended purpose of the types of entities and relations in the knowledge graph. Specifically, the present invention is advantageously configured to signal when new entities and new relationships between entities begin to diverge from the types of entities and relations already in the knowledge graph. The present invention, for the first time, provides a user with an indication when an emerging concept is diverging significantly from a concept embodied by a knowledge graph. This improvement to the art of knowledge graphs utilizes vector space models involving relations to compute emerging concepts for new data items being added to a knowledge graph and to compute concepts for the existing entities and relations in the knowledge graph to provide insight to users related to concept drift.

Embodiments of the present invention relates to methods, and associated computer system and computer program product, for signaling concept drift during knowledge base population. One or more processors of a computer system receive a knowledge graph and a text collection. For example, the knowledge graph may include one or more of:
1) entities i1, i2, i3, etc. linked via relations r1, r2, r3, etc. to form a graph of relationships p1=<i1, r1, i3>, p2=<i2, r2, i2>, etc.;
2) a set of entity type links between instance entities and their entity types <i1, t1>, <t2, t1>, etc.;
3) a set of relation type links between relationships and relations <p1,r1>, <p2,r2>,etc.
4) a list of definitions of each relation as a tuple relating entity types and relations <t1, r1, t2>, <t2, r2, t4>, etc.; and
5) surface forms of the entities that are alternate ways of expressing the entities in a natural language.
   The entities are each a sequence of characters. The instance entities in knowledge graphs are the extensional definition of entity types to which they are linked. For example, “university” may be extensionally defined in terms of examples that are instance entities: “University of Florida”, “Harvard University”, and “Stevens Institute of Technology”. Similarly, the relation “president of” may be extensionally defined in terms of examples that are relationships such as “Macron, president of, France”, “Bacow, president of, Harvard”. The text collection includes, for example, a collection of documents. The one or more processors may find mentions of the surface forms of the instance entities in the text collection as tokens. The one or more processors may further find additional tokens as sequences of characters (e,g, words, phrases, nouns, noun phrases, etc.) in the documents in the text collection. The one or more processors may then build knowledge graph vector spaces of the text collection (e.g. using a shallow neural network) using the tokens and portions of text surrounding the mentions of the surface forms of the instance entities. One knowledge graph vector space may be a vector space for entities. Another knowledge graph vector space may be a vector space for relationships as tuples of entities. The one or more processors embed the instance entities and relationships in the knowledge graph vector spaces to compute an instance entity vector for each instance entity in the knowledge graph and/or compute a relationship vector for each relationship in the knowledge graph. The one or more processors may compute an entity type concept vector for each entity type which may be a function of the instance entity vectors for each instance entity linked to the entity type. Alternatively or additionally, the one or more processors may compute a relation concept vector for each relation which may be a function of the relationship vector for each relationship linked by a relation type link to the relation.

Once the concept vector for each entity type and/or relation are computed, embodiments of the invention contemplate the one or more processors receiving a new sequence of data items to populate the knowledge graph. The one or more processors receive an association between the data items and an entity in the knowledge graph or between tuples of data items and relations in the knowledge graph. The one or more processors may then find mentions of each data item in the text collection and mentions of each relationship between data items, for example using surface forms. The one or more processors embed the data items and relationships between data items in knowledge graph vector space. The one or more processors may then compute a data item vector for each data item and compute an emerging entity type concept vector for each entity type. The emerging entity type concept vector is a function of the instance entity vectors for each instance entity linked to the entity type. Additionally or alternatively, the one or more processors may also compute an emerging relation concept vector for each relation. The relation concept vector is a function of all the relationship vectors for each relationship linked by a relation type link to the relation. For entities, the one or more processors generate a signal for concept drift of an entity type when the distance in the knowledge graph vector space between the entity type concept vector and the emerging entity type concept vector is greater than a concept drift threshold. For relations, the one or more processors generate a signal for concept drift of a relation when the distance in the knowledge graph vector space between the emerging relation concept vector and the relation concept vector is greater than a relation concept drift threshold.

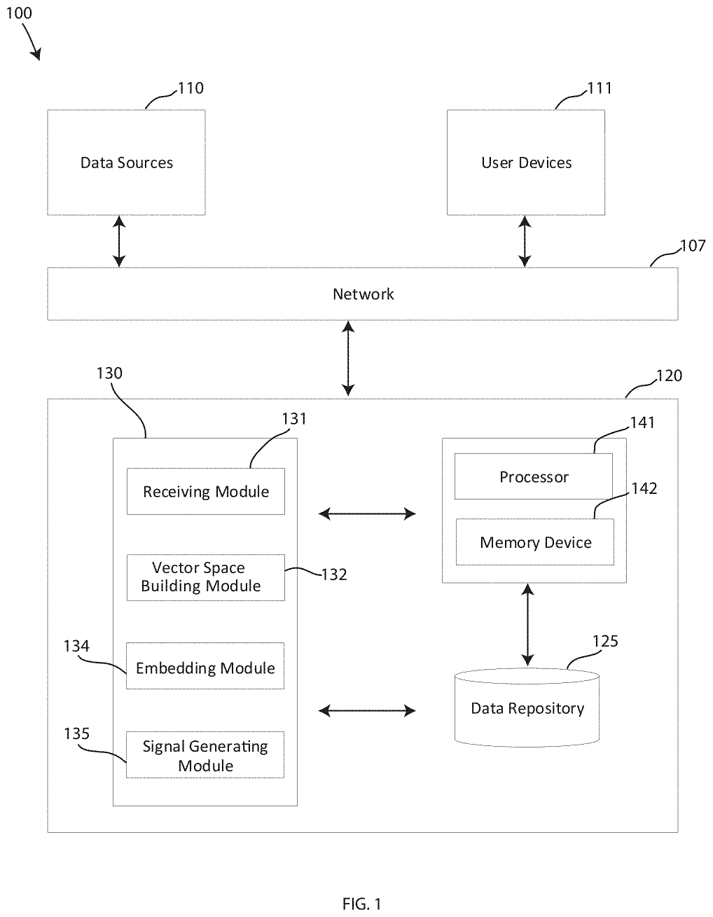

FIG. 1 depicts a block diagram of a system for signaling concept drift during knowledge base population 100, in accordance with embodiments of the present invention. Embodiments of the system for signaling concept drift during knowledge base population 100 may be conducted by a computer system 120. Embodiments of the computing system 120 may be a computer system, a computer, a server, one or more servers, a cloud computing device, a hardware device, a remote server, and the like. The system for signaling concept drift during knowledge base population 100 and/or computer system 120 may be configured to receive a knowledge graph, receive a text collection, receive a sequence of data item entities (e.g. <“Macron”, “Harvard”>) and/or a sequence of sets of data items as relationships (e.g. <“Macron, France”, “Bacow, Harvard”>), parse tokens from the text collection using the knowledge graph, build a vector space of the tokens, link data items and/or relationships composed of the data items in the text to knowledge graph entity type and/or relation, and generate a signal, warning, or other indication to a user when concept drift is detected.

Furthermore, embodiments of system for signaling concept drift during knowledge base population 100 may include one or more data sources 110 and one or more user devices 111 communicatively coupled to the computing system 120 of the system for signaling concept drift during knowledge base population 100 over a network 107.

The network 107 may be a 4G, 5G and/or LTE based cellular data network or system. The network 107 may be a cloud network or system. Further embodiments of network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA or a mobile communications data network. The architecture of the computer network 107 may be a peer-to-peer network in some embodiments, wherein in other embodiments, the network 107 may be organized as a client/server architecture.

Embodiments of the one or more data sources 110 of the system for signaling concept drift during knowledge base population 100 may be any document corpus provided by a user, entity of other system. The one or more data sources 110 may be text data in a single language or multiple languages. The one or more data sources 110 may be configured to provide the computer system 120 with one or more large or structured set of texts. For example, the one or more data sources 110 may be a web entity, such as Wikipedia. The one or more data sources 110 may be an academic journal database, a historical newspaper database, or any other database with textual data. The one or more data sources 110 may be configured to provide some or all of the data stored therein. For example, the one or more data sources 110 may be interacted with by a user to determine the exact subset of data from the one or more data sources 110 to provide to the computer system 120.

Embodiments of the one or more user devices 111 may be a device operated by a user that is configured to interact with the computer system 120 and both provide information or inputs to the computer system 120 and receive outputs from the computer system 120. The one or more user devices 111 may be operated by a user in providing data from the one or more data sources 110 to the computer system 120 for analysis therein, in accordance with the methods described herein. The one or more user devices 111 may be configured to provide the computer system 120 with a selected subset of data from the data that has been provided to the computer system 120 from the one or more data sources 110. For example, the one or more user devices 111, operated by a user, may be configured to provide the computer system 120 with a corpus of 300,000 technology notes from a technology journal database. The one or more user devices 111 may enable to user to make a selection of a subset of entities for the computer system 120 to populate a knowledge graph. For example, the one or more user devices 111 may select “database” as a type of entity and the computer system 120 may populate a knowledge graph with a plurality of databases (e.g. Oracle®, DB2 @, etc.) found in the 300,000 technology notes. The one or more user devices 111 may thus be configured to receive a knowledge graph output from the computer system 120 for consumption by a user of the one or more user devices 111. The one or more user devices 111 may further be configured to receive notifications, signals, or other outputs from the computer system 120 for signaling when concept drift may occur in a knowledge graph created by the computer system 120.

The knowledge graph may include entities and/or relations connecting entities. The entities may be of a given type. For example, “database” and “operating system” might be the entity types, “runsOn” might be the relation, “DB2” and “SQL Server” might entities of type “database”. “DB2 runsOn Unix” and “SQL Server runsOn Windows” are the relationships.

Embodiments of the computing system 120 include a module structure 130 that includes a receiving module 131, a vector space building module 132, an embedding module 134, and a signal generating module 135. A “module” herein refers to any hardware-based module, software-based module, or combination thereof. Embodiments of hardware-based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the receiving module 131 may include one or more components of hardware and/or software program code for receiving information and/or data from the one or more data sources 110 and the one or more user devices 111. The receiving module 131 may be configured to receive a sequence of data items. The receiving module 131 may also be configured to receive a sequence of pairs, triples, or other tuples of data items. The receiving module 131 may be configured to accept a knowledge graph. The receiving module 131 may be configured to accept an association between the sequence of data items and a type of entity in the knowledge graph, including a link between the sequence of data items and the entity. The receiving module 131 may be configured to accept an association between the sequence of tuples and a relation in the knowledge graph, including a link between the sequence of tuples and the relation. The receiving module 131 may be configured to accept a corpus of text-based information from the one or more data sources 110. The new sequence of data items or sequence of tuples of data items may be new information, or a modified entity or relationship example from a user or automated system (i.e. streaming news) that is added to a list of existing entities and/or relationships. The receiving module 131 may be configured to add this new sequence of data items or sequence of tuples of data items to the list of already received sequence of data items. Still further, the receiving module 131 may be configured to receive entity and/or relationship inputs from a user related to the received data. The receiving module 131 may be still further configured to receive various other setting or customization inputs from the one or more user devices 111 and/or the users.

Embodiments of the vector space building module 132 may include one or more components of hardware and/or software program code for building a vector space for the received corpus of text-based information. The vector space building module 132 may be configured to build a vector space related to the received textual data. The vector space building module 132 may be configured to split a document collection into context windows (e.g. sentences or paragraphs), and parse or extract entities or relations (including more than one entity) as natural language chunks (e.g. noun phrases, named entities, etc.) from each context window. The vector space building module 132 may be configured to index each of the context windows by entities and relations. The vector space building module 132 may be configured to build the vector space for the received sequence of data items, and any new sequence of data items related to an emerging concept that are later received and added to an existing vector space.

Embodiments of the embedding module 134 may include one or more components of hardware and/or software program code for embedding entities and relations in the vector space. The embedding module 134 may be a sub-module of the vector space building module 132. The embedding module 134 may be configured to map an entity or relation to a vector of continuous numbers. This may allow the vector space building module 132 to create the vector space.

Embodiments of the signal generating module 135 may include one or more components of hardware and/or software program code for generating a signal when the cosine distance or dot product distance between a centroid vector of entities and relationships defining the concept from the knowledge graph that are in the vector space and a centroid vector of the received new sequence of data items or sequence of tuples of data items is greater than a concept drift threshold. Specifically, the signal generating module 135 may be configured to compute both a knowledge graph concept vector and an emerging concept vector. The knowledge graph concept vector may be computed by the embedding module 132 as a function of the vectors for entities and/or relations in the knowledge graph. In some embodiments, the knowledge graph concept is a connected graph of entities and relations. In such embodiments, the embedding module 132 uses measure of the magnitude of the centrality of the entities and/or relations in the connected graph combined with the magnitude of the vectors for entities and/or relations. Similarly, the emerging concept vector may be a function of the vectors of the entities and/or relation examples and the graph centrality).

The signal generating module 135 may be configured to highlight data items according to a distance from the vector of knowledge graph concept. The signal generating module 135 may be configured to present a data item outlier to a user and/or a user device, such as the one or more user devices 111. The signal generating module 135 may be configured to alert a user or system, such as the one or more user devices 111, of the concept drift if the concept of the type of entities and/or relations selected from the corpus of documents newly received starts to diverge sufficiently from the concept of the type of entities and/or relations in the existing vector space.

The signal generating module 135 may utilize dot product or cosine similarity to determine each of the knowledge graph concept vector and the emerging concept vector. The signal generating module 135 may be configured to color each example corresponding to the cosine distance or dot product distance or dot product distance. The signal generating module 135 may be configured to enable the user to add, remove, or edit the documents in the document corpus of the received sequence of data items, thus rebuilding the knowledge graph vector space. The signal generating module 135 may further be configured to crowd source the sequence of data items by having a set of users provide data items. Still further, the threshold for determining when a signal is generated (the concept drift threshold) may be customized by a user, or learned by supervised machine learning methods (e.g. through positive and/or negative feedback by a user).

Further, embodiments of the computing system 120 may be equipped with a memory device 142 which may store various data/information/code, and a processor 141 for implementing the tasks associated with the system for signaling concept drift during knowledge base population 100 and perform processing associated with the functionality of the module structure 130.

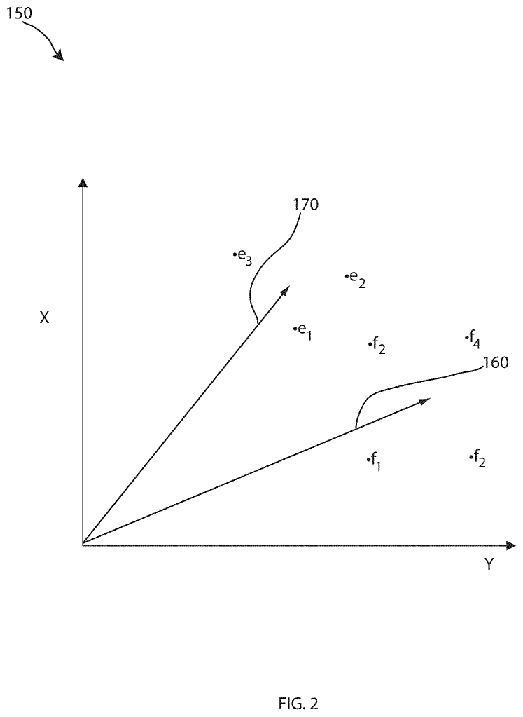

FIG. 2 depicts a knowledge graph vector space 150 created by the system for signaling concept drift during knowledge base population of FIG. 1, in accordance with embodiments of the present invention. The knowledge graph vector space 150 is shown including a concept vector 160. The knowledge graph vector space pertains to entities, but it should be understood that the same concepts may be applied to relations. Each entity has an entity vector. In knowledge graphs plotting relation vectors, each relationship may similarly have a relationship vector. Each entity type has an entity type vector computed from the entity vectors for each of the entities for which it is a type. In knowledge graphs pertaining to relations, each relation would have a relation vector computed from the relationship vectors of each of the relationships for which it is a relation. The concept vector 160 is shown as the centroid of the vectors of the entities in the knowledge graph₁, f₂, f₃, f₄ within an existing vector space built and trained from a corpus of documents; the emerging concept vector 170 is shown as a centroid of the vectors for received entities e₁, e₂, e₃ that are received as data items associated with entity types.

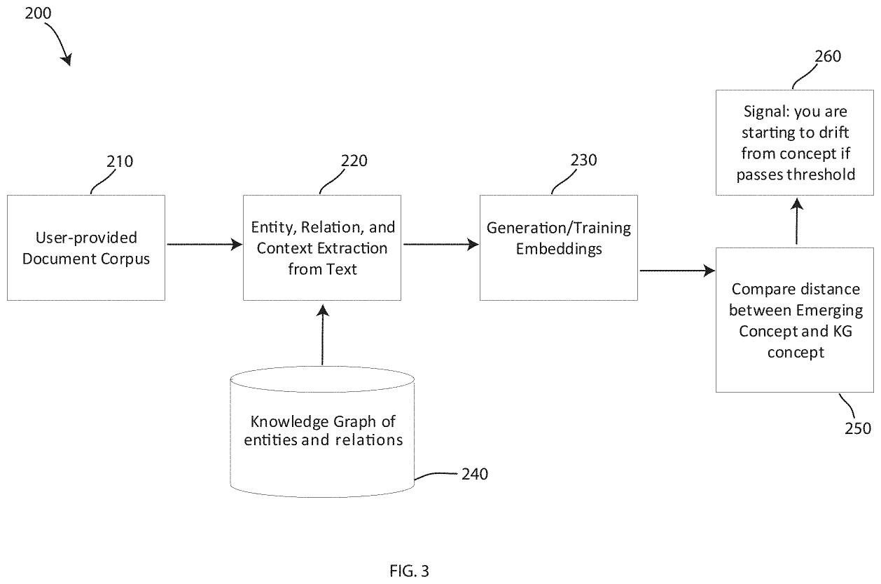

FIG. 3 depicts a process flow 200 performed by the system for signaling concept drift during knowledge base population 100 of FIG. 1, in accordance with embodiments of the present invention. As shown, a user first provides a document corpus at a step 210 of the process to the computer system 120, which is received by the receiving module 131. The computer system 120, and specifically the vector space building module 132, extracts entities, relations and context from the received text at a step 220 of the process. The computer system uses the knowledge graph of entities and relations located in a data storage location 240. Specifically, the system locates the surface form variant spellings of entities from the knowledge graph in the document corpus. From there, at a step 230, the computer system 120, and the embedding module 134, generates and/or trains embeddings from the text in the document corpus. Entities of knowledge graphs of entity and/or relation types may be utilized by the modules 132, 134 at a step 240. From here, the knowledge graph concept vectors (entity type concept vectors and relation concept vectors) 160 may be generated or otherwise computed, along with the emerging concept vectors (emerging entity type concept vectors and emerging relation type concept vectors) 170 and the cosine of the angles between these two vectors may be computed at step 250. Finally, at a step 260, a signal is generated and sent to a user device such as the user device 111 if the cosine distance or dot product distance or dot product distance between the knowledge graph concept vector 160 and the emerging concept vector 170 is greater than a threshold. This threshold can be learned from user feedback as it is determined through knowledge base population how much cohesion is desired by the user. The threshold can be tuned or set for each entity type and relation or can be global across the knowledge graph with one setting for all relations and one setting for all entity types. The default setting is 0.20. It may be set by the user. It may be associated with the tool that the user uses to input data items. Some entities may be more central in the knowledge graph than others as measured by a graph centrality measure. The signal for concept drift may be attenuated by the centrality of the entities in the knowledge graph and/or the centrality of the graph of data items.

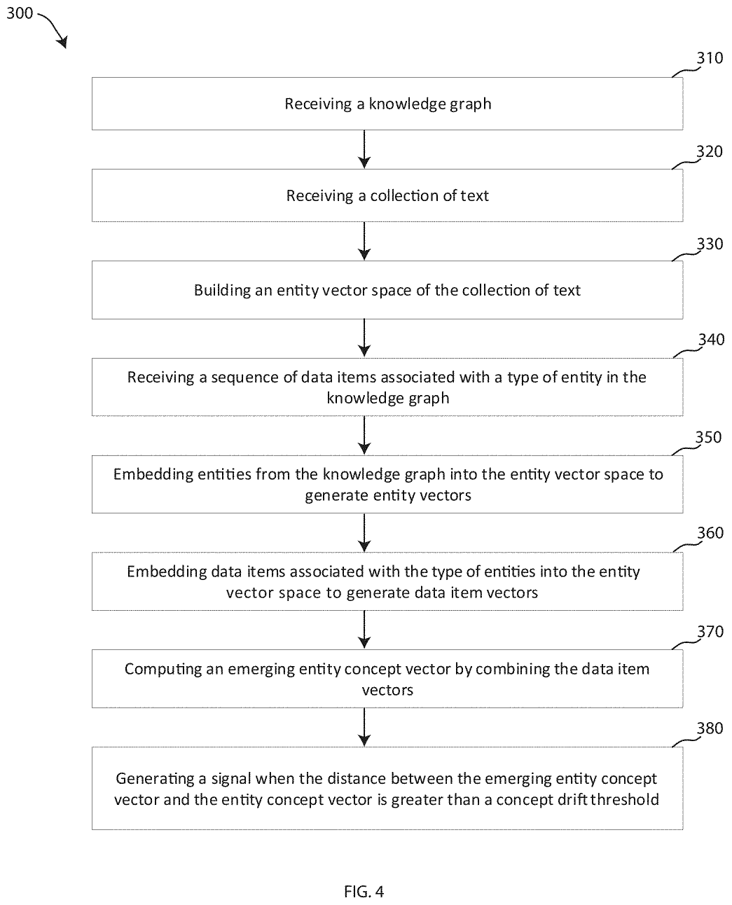

FIG. 4 depicts a method 300 for signaling concept drift during knowledge base population, in accordance with embodiments of the present invention. The method 300 may be performable by the system for signaling concept drift during knowledge base population 100. The method 300 may include a step 310 of receiving, accepting, or otherwise obtaining, by one or more processors of a computer system such as computer system 120, a knowledge graph. The knowledge graph may define a concept that is, for example, an entity. The method 300 includes a step 320 of receiving a collection of text. The collection of text may be a corpus of documents from one or more data sources, such as the data sources 110. The method 300 may include a step 330 of building, by the one or more processors of the computer system, an entity vector space of the received collection of text.

The method 300 may include another step 340 of receiving, by the one or more processors of the computer system, a sequence of data items associated with a type of entity in the knowledge graph. The sequence of data items may be a collection of text, corpus of additional documents from one or more data sources, a window or a data entry generated by program, or the like. The method 300 includes another step 350 of embedding, by the one or more processors of the computer system, entities from the knowledge graph into the entity vector space to generate entity vectors. The method 300 includes a step 360 of embedding, by the one or more processors of the computer system, data items associated with the type of entities into the entity vector space to generate data item vectors.

The steps 350, 360 may use embeddings and autoencoders. The steps 350, 360 may further include building a graph of data item tuples where the difference is computed as a dot product. Still further, the steps 350, 360 may include building a graph of data item tuples where the magnitude of the vector is computed using a graph metric. The steps 350, 360 may include splitting a document collection into context windows (e.g. sentences or paragraphs), and extracting entities as natural language text chunks (nouns, phrases, named entities, etc.) from each context window. The steps 350, 360 may include indexing each of the context windows by the entities and learning an embedding space (reduced dimensional representation) for each entity. The steps 350, 360 may further include computing entities for each of the entity examples in the knowledge graph using the embedding vector space.

Finally, the method 300 includes a step 390 of generating, by the one or more processors of the computer system, a signal when the cosine distance or dot product distance between the emerging entity concept vector and the entity concept vector is greater than a concept drift threshold. The step 390 may include highlighting data items according to a degree of difference between the emerging entity concept vector and the entity concept vector. The step 390 may include presenting a data item outlier to a user and/or a user device, such as the one or more user devices 111. The method step 390 may include signaling concept drift if the emerging concept starts to diverge sufficiently from the knowledge graph concept. This step 390 may include alerting a user or system, such as the one or more user devices 111, of the concept drift if the concept of the type of entities selected from the corpus of documents newly received starts to diverge sufficiently from the concept of the type of entities in the existing knowledge graph vector space. The method step 390 may utilize degree centrality, betweenness centrality, Kartz centrality, or other graph centrality measures in addition to the magnitude of each of the emerging concept entity vector and the entity concept vector. The step 390 may include highlighting colors of each of example corresponding to the cosine distance or dot product distance or graph centrality. The method step 390 may include enabling the user to change the document corpus of the received sequence of data items by editing documents or adding and removing documents from the list being utilized to generate a knowledge graph vector space. The step 390 may further include crowd sourcing the creation of the original knowledge graph vector space. Still further, the threshold for determining when a signal is generated (the concept drift threshold) may be customized by a user, or learned by supervised machine learning methods (e.g. through positive and/or negative feedback by a user).

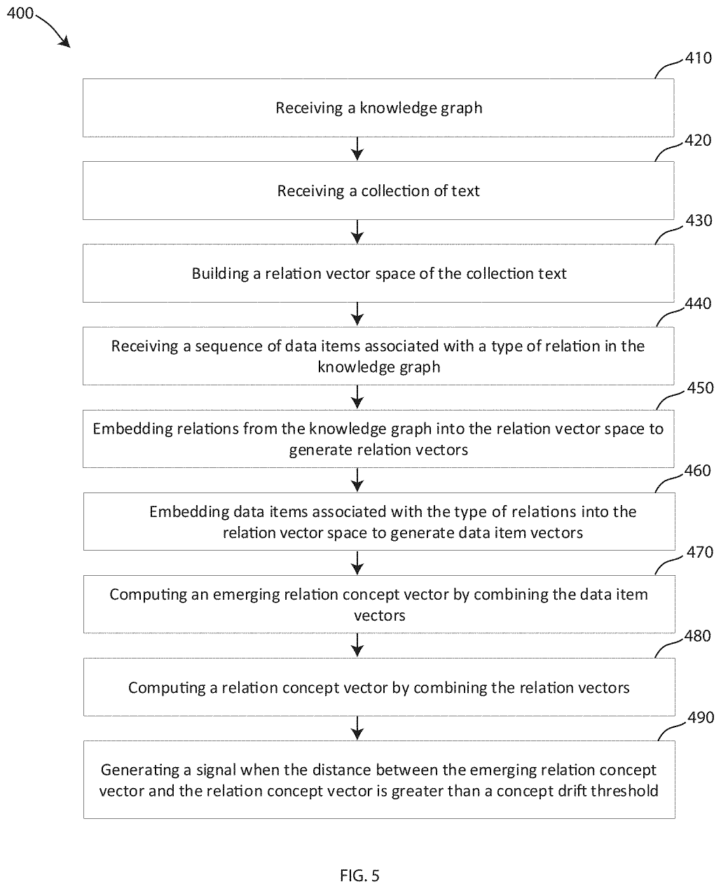

FIG. 5 depicts a method 400 for signaling concept drift during knowledge base population, in accordance with embodiments of the present invention. The method 400 may be performable by the system for signaling concept drift during knowledge base population 100. The method 400 may include a step 410 of receiving, accepting, or otherwise obtaining, by one or more processors of a computer system such as computer system 120, a knowledge graph. The knowledge graph may define a concept that is, for example, a relation. The method 400 includes a step 420 of receiving a collection of text. The collection of text may be a corpus of documents from one or more data sources, such as the data sources 110. The method 400 may include a step 430 of building, by the one or more processors of the computer system, a relation vector space of the received collection of text.

The method 400 may include another step 440 of receiving, by the one or more processors of the computer system, a sequence of data items associated with a type of relation in the knowledge graph. The sequence of data items may be a collection of text, corpus of additional documents from one or more data sources, a window or a data entry generated by program, or the like. The method 400 includes another step 450 of embedding, by the one or more processors of the computer system, relations from the knowledge graph into the relation vector space to generate relation vectors. The method 400 includes a step 460 of embedding, by the one or more processors of the computer system, data items associated with the type of relations into the relation vector space to generate data item vectors.

The steps 450, 460 may use embeddings and autoencoders. The steps 450, 460 may further include building a graph of data item tuples where the difference is computed as a dot-product. Still further, the steps 450, 460 may include building a graph of data item tuples where the magnitude of the vector is computed using a graph metric. The steps 450, 460 may include splitting a document collection into context windows (e.g. sentences or paragraphs), and extracting entities (or pairs of entities) as natural language text chunks (nouns, phrases, named entities, etc.) from each context window. The steps 450, 460 may include indexing each of the context windows by the entities and learning an embedding space (reduced dimensional representation) for each relation. The steps 450, 460 may further include computing relation example vectors for each of the relation examples in the knowledge graph using the embedding vector space.

The method 400 may thereby include a step 470 of computing, by the one or more processors of the computer system, an emerging relation concept vector by computing the centroid of the data item vectors. The method 400 may thereafter include a step 470 of computing, by the one or more processors of the computer system, a relation concept vector by computing the centroid of the relation vectors.

Finally, the method 400 includes a step 490 of generating, by the one or more processors of the computer system, a signal when the cosine distance or dot product distance between the emerging relation concept vector and the relation concept vector is greater than a concept drift threshold. The step 490 may include highlighting data items according to a degree of difference between the emerging relation concept vector and the relation concept vector. The step 490 may include presenting a data item outlier to a user and/or a user device, such as the one or more user devices 111. The method step 490 may include signaling concept drift if the emerging concept starts to diverge sufficiently from the knowledge graph concept. This step 490 may include alerting a user or system, such as the one or more user devices 111, of the concept drift if the concept of the type of relations selected from the corpus of documents newly received starts to diverge sufficiently from the concept of the type of relations in the existing knowledge graph vector space. The method step 490 may utilize cosine similarity to determine the central magnitude of each of the emerging concept relation vector and the relation concept vector. The step 490 may include highlighting colors of each of example corresponding to the cosine distance or dot product distance. The method step 490 may include enabling the user to change the document corpus of the received sequence of data items by editing documents or adding and removing documents from the list being utilized to generate a knowledge graph vector space. The step 490 may further include crowd sourcing the creation of the original knowledge graph vector space. Still further, the threshold for determining when a signal is generated (the concept drift threshold) may be customized by a user, or learned by supervised machine learning methods (e.g. through positive and/or negative feedback by a user).

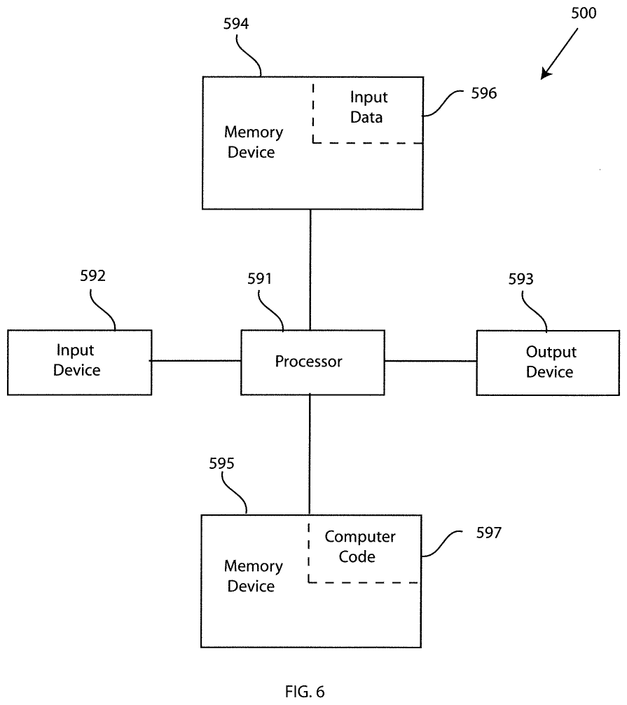

FIG. 6 depicts a block diagram of an exemplary computer system that may be included in the system for signaling concept drift during knowledge base population 100 of FIG. 1, capable of implementing methods and process flows for signaling concept drift during knowledge base population of FIGS. 3-5, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing method and processes for signaling concept drift during knowledge base population in the manner prescribed by the embodiment of FIGS. 3-5 using one, some or all of the system for signaling concept drift during knowledge base population 100 of FIG. 1, wherein the instructions of the computer code 597 may be executed by processor 591 via memory device 595. The computer code 597 may include software or program instructions that may implement one or more algorithms for implementing the methods and processes for signaling concept drift during knowledge base population, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer-readable program embodied therein and/or having other data stored therein, wherein the computer-readable program comprises the computer code 597. Generally, a computer program product (or, alternatively, an article of manufacture) of the computer system 500 may comprise said computer usable storage medium (or said program storage device).

Memory devices 594, 595 include any known computer-readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the touchscreen of a computing device. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from one or more computer data storage units (not shown). The one or more computer data storage units include a known computer-readable storage medium, which is described below. In one embodiment, the one or more computer data storage units may be a non-volatile data storage device, such as a magnetic disk drive (i.e., hard disk drive) or an optical disc drive (e.g., a CD-ROM drive which receives a CD-ROM disk). In other embodiments, the one or more computer data storage unit may include a knowledge base or data repository 125, such as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to identification validation systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to perform the method for signaling concept drift during knowledge base population. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for signaling concept drift during knowledge base population. Thus, the present invention discloses a process for supporting, deploying and/or integrating computer infrastructure, integrating, hosting, maintaining, and deploying computer-readable code into the computer system 500, wherein the code in combination with the computer system 700 is capable of performing a method for signaling concept drift during knowledge base population.

A computer program product of the present invention comprises one or more computer-readable hardware storage devices having computer-readable program code stored therein, said program code containing instructions executable by one or more processors of a computer system to implement the methods of the present invention.

A computer system of the present invention comprises one or more processors, one or more memories, and one or more computer-readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics areas follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models areas follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

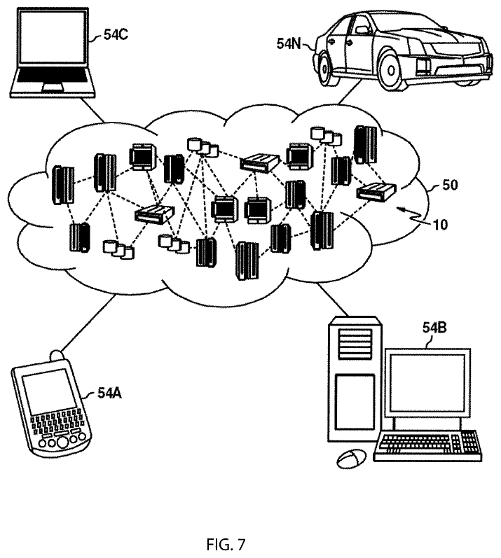

Referring now to FIG. 7, illustrative cloud computing environment 50 is depicted. As shown, cloud computing environment 50 includes one or more cloud computing nodes 10 with which local computing devices used by cloud consumers or users, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 7 are intended to be illustrative only and that computing nodes 10 and cloud computing environment 50 can communicate with any type of computerized device over any type of network and/or network addressable connection (e.g., using a web browser).

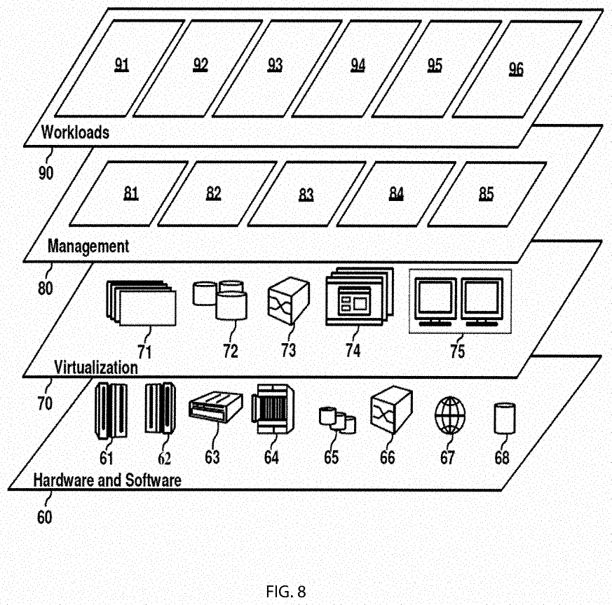

Referring now to FIG. 8, a set of functional abstraction layers provided by cloud computing environment 50 (see FIG. 7) are shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93, data analytics processing 94; transaction processing 95; and signaling concept drift during knowledge base population 96.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for signaling concept drift during knowledge base population, the method comprising:
receiving, by one or more processors of a computer system, a knowledge graph;
receiving, by the one or more processors of the computer system, a collection of text;
building, by the one or more processors of the computer system, a vector space of the collection of text:
receiving, by one or more processors of a computer system, a sequence of data items associated with: A) a type of entity; or B) a relation, in the knowledge graph;
embedding, by the one or more processors of the computer system, entities or relations from the knowledge graph into the vector space to generate entity or relation vectors;
embedding, by the one or more processors of the computer system, data items associated with: A) the type of entity; or B) the relation into the vector space to generate data item vectors;
computing, by the one or more processors of the computer system, an emerging entity or relation concept vector by determining a centroid of the data item vectors;
computing, by the one or more processors of the computer system, an entity or relation concept vector by determining a centroid of the entity or relation vectors; and
generating, by the one or more processors of the computer system, a signal when a distance between the emerging entity or relation concept vector and the entity or relation concept vector is greater than a concept drift threshold.

2. The method of claim 1, wherein the building the vector space of the received sequence of data items uses embeddings and autoencoders.

3. The method of claim 1, wherein the generating the signal includes highlighting data items according to a degree of difference with the centroid of the data item vectors.

4. The method of claim 1, wherein the generating the signal includes presenting a data item outlier.

5. The method of claim 1, wherein the distance is computed as a cosine distance or dot product distance.

6. The method of claim 1, wherein the building the vector space of the received sequence of data items further includes building a graph of data item tuples where the magnitude of the vector is computed using a graph metric.

7. The method of claim 1, wherein the sequence of data items corresponds to at least one of a recent time window or a data entry, and is generated by a program.

8. A computer system, comprising:
one or more processors;
one or more memory devices coupled to the one or more processors; and
one or more computer readable storage devices coupled to the one or more processors, wherein the one or more storage devices contain program code executable by the one or more processors via the one or more memory devices to implement a method for signaling concept drift during knowledge base population, the method comprising:
receiving, by the one or more processors of the computer system, a knowledge graph;
receiving, by the one or more processors of the computer system, a collection of text;
building, by the one or more processors of the computer system, a vector space of the collection of text;
receiving, by one or more processors of a computer system, a sequence of data items associated with: A) a type of entity; or B) a relation, in the knowledge graph;
embedding, by the one or more processors of the computer system, entities or relations from the knowledge graph into the vector space to generate entity or relation vectors;
embedding, by the one or more processors of the computer system, data items associated with: A) the type of entity; or B) the relation into the vector space to generate data item vectors;
computing, by the one or more processors of the computer system, an emerging entity or relation concept vector by determining a centroid of the data item vectors;
computing, by the one or more processors of the computer system, an entity or relation concept vector by determining a centroid of the entity or relation vectors; and
generating, by the one or more processors of the computer system, a signal when a distance between the emerging entity or relation concept vector and the entity or relation concept vector is greater than a concept drift threshold.

9. The computer system of claim 8, wherein the building the vector space of the received sequence of data items uses embeddings and autoencoders.

10. The computer system of claim 8, wherein the generating the signal includes highlighting data items according to a degree of difference with the centroid of the data item vectors.

11. The computer system of claim 8, wherein the generating the signal includes presenting a data item outlier.

12. The computer system of claim 8, wherein the distance is computed as a cosine distance or a dot-product distance.

13. The computer system of claim 8, wherein the building the vector space of the received sequence of data items further includes building a graph of data item tuples where the magnitude of the vector is computed using a graph metric.

14. The computer system of claim 8, wherein the sequence of data items corresponds to at least one of a recent time window or a data entry, and is generated by a program.

15. A computer program product, comprising one or more computer readable hardware storage devices storing a computer readable program code, the computer readable program code comprising an algorithm that when executed by one or more processors of a computing system implements a method for signaling concept drift during knowledge base population, the method comprising:
receiving, by the one or more processors of the computer system, a knowledge graph;
receiving, by the one or more processors of the computer system, a collection of text;
building, by the one or more processors of the computer system, a vector space of the collection of text;
receiving, by one or more processors of a computer system, a sequence of data items associated with: A) a type of entity; or B) a relation, in the knowledge graph;
embedding, by the one or more processors of the computer system, entities or relations from the knowledge graph into the vector space to generate entity or relation vectors;
embedding, by the one or more processors of the computer system, data items associated with: A) the type of entity; or B) the relation into the vector space to generate data item vectors;
computing, by the one or more processors of the computer system, an emerging entity or relation concept vector by determining a centroid of the data item vectors;
computing, by the one or more processors of the computer system, an entity or relation concept vector by determining a centroid of the entity or relation vectors; and
generating, by the one or more processors of the computer system, a signal when a distance between the emerging entity or relation concept vector and the entity or relation concept vector is greater than a concept drift threshold.

16. The computer program product of claim 15, wherein the building the vector space of the received sequence of data items uses embeddings and autoencoders.

17. The computer program product of claim 15, wherein the generating the signal includes highlighting data items according to a degree of difference with the centroid of the data item vectors.

18. The computer program product of claim 15, wherein the generating the signal includes presenting a data item outlier.

19. The computer program product of claim 15, wherein the distance is computed as a cosine distance or a dot-product distance.

20. The computer program product of claim 15, wherein the building the vector space of the received sequence of data items further includes building a graph of data item tuples where the magnitude of the vector is computed using a graph metric.
